(19) United States
(12) Patent Application Publication
(10) Pub. No.: US 2003/0002934 A1
(43) Pub. Date: Jan. 2, 2003

(54) Power hand drill outer shell arrangement

(76) Inventor: Hung-Ming Hsu, Tai Chung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/895,249

(22) Filed: Jul. 2, 2001

(51) Int. Cl. B23B 45/00

(52) U.S. Cl. 408/16; 408/124; 408/241 R

(57) ABSTRACT

A power hand drill outer shell arrangement includes a cover shell, the cover shell having equiangularly spaced peripheral lugs and an integrated switch seat holding a transmission gear box control switch; and a housing abutted against the cover shell, the housing having axially extended mounting holes respectively fastened to the peripheral lugs of the cover shell, and a front opening, which receives the switch seat.

### BACKGROUND OF THE INVENTION

1. Field of the Invention

The present invention relates to a power hand drill and, more specifically, to the arrangement of a power hand drill outer shell.

2. Description of the Prior Art

A conventional power hand drill is shown in FIG. 1, comprising a torque adjusting mechanism 30 between the chuck 10 and the transmission gear box 20. The torque adjusting mechanism 30 comprises a rotary torque adjustment ring 31 disposed adjacent to the chuck 10, a torque control (not shown), and a cover shell 32 covering the torque control. The housing 40 of the power hand drill covers the cover shell 32 and other movable members of the power hand drill except the chuck 10 and the rotary torque adjustment ring 31. The housing 40 is provided with a sliding slot 34 in which a sliding switch 33 is installed to control the transmission gear box 20. This design of housing for power hand drill has drawbacks as outlined hereinafter:

1. When inspecting or repairing the internal torque control, the housing must be detached from the power hand drill so that the cover shell and the transmission gear box can be opened for a maintenance work.

2. Because the housing covers over the cover shell of the torque adjusting mechanism, the front side of the housing must be tapered to fit the periphery of the cover shell, however this limitation complicates the fabrication of the housing.

3. During the operation of the torque control, much heat is produced, however the plastic housing is a barrier to the dissipation of heat. Accumulation of heat inside the housing may damage the internal mechanism of the power hand drill.

4. The housing is not suitable for the installation of an external lamp for enabling the power hand drill to be used in the dark.

### SUMMARY OF THE INVENTION

The present invention has been accomplished under the circumstances in view. It is the main object of the present invention to provide a power hand drill outer shell arrangement, which eliminates the drawbacks of the aforesaid conventional design. According to one aspect of the present invention, the power hand drill outer shell arrangement of the present invention comprises a metal cover shell, the cover shell having equiangularly spaced peripheral lugs and an integrated switch seat holding a transmission gear box control switch; and a housing abutted against the cover shell, the housing having axially extended mounting holes respectively fastened to the peripheral lugs of the cover shell, and a front opening, which receives the switch seat. Because the housing is abutted against the cover shell but not covering the cover shell, it is not necessary to have the front side of the housing tapered, and the housing is not a barrier to the dissipation of heat to the metal cover shell. Therefore, the fabrication of the housing is simple. According to another aspect of the present invention, the housing further comprises a receiving hole remote from the front opening, and a lamp unit hinged to the peripheral wall of the receiving hole and turned between an operative position outside the receiving hole and a non-operative position inside the receiving hole.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a conventional power hand drill.

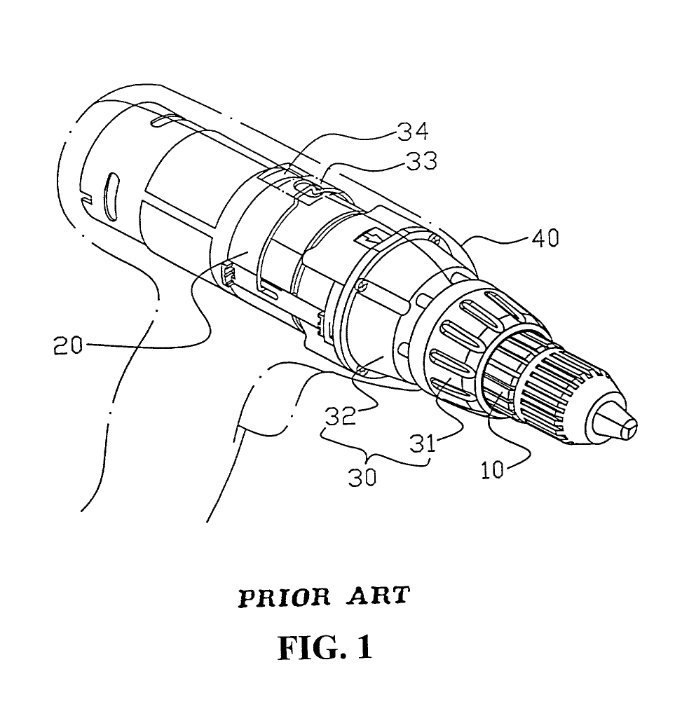

FIG. 2 is a perspective view of a power hand drill constructed according to the present invention;

FIG. 3 is an exploded view of a part of the power hand drill shown in FIG. 2; and

FIG. 4 is an exploded view in an enlarged scale of the lamp unit shown in FIG. 2.

### DETAILED DESCRIPTION OF THE PREFERRED EMBODIMENT

For the purpose of promoting an understanding of the principles of the invention, reference will now be made to the embodiment illustrated in the drawings. Specific language will be used to describe same. It will, nevertheless, be understood that no limitation of the scope of the invention is thereby intended, alterations and further modifications in the illustrated device, and further applications of the principles of the invention as illustrated herein being contemplated as would normally occur to one skilled in the art to which the invention relates.

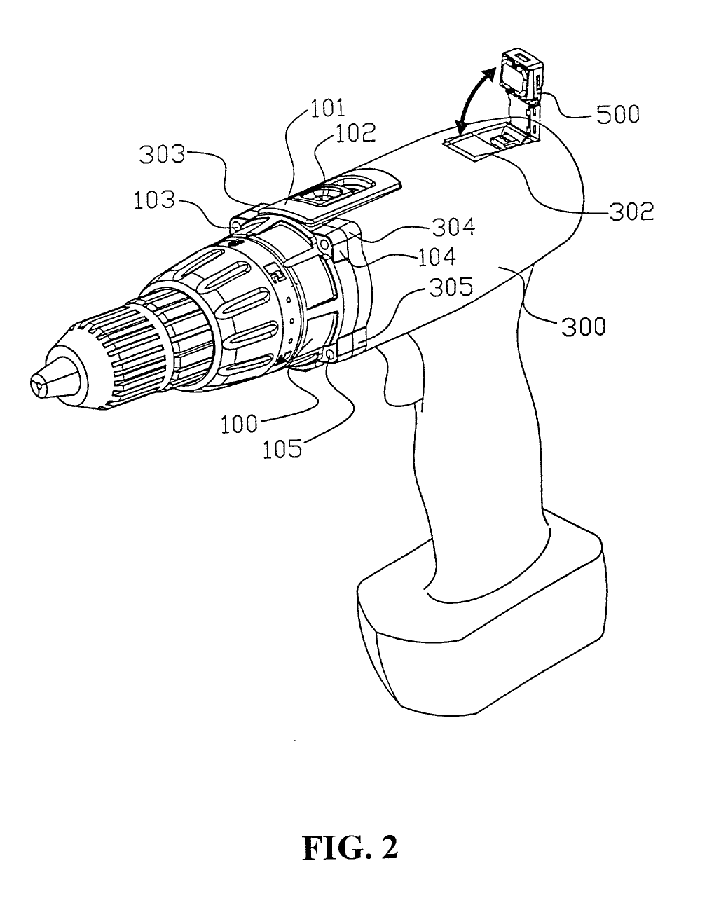

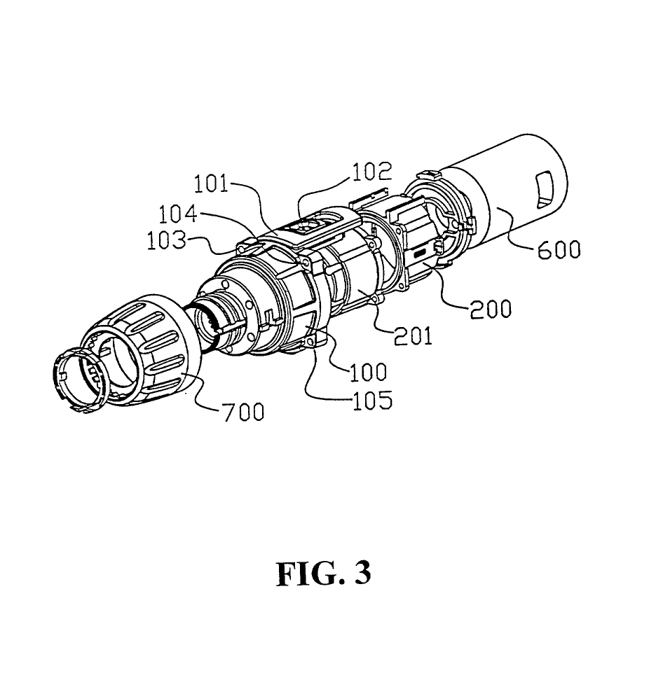

Referring to FIGS. 2 and 3, the cover shell 100 comprises a plurality of equiangularly spaced peripheral lugs 103;104;105, and a switch seat 101 extended from one side thereof toward the transmission gear box 200 and holding a switch 102 that controls the operation of the transmission gear box 200. The housing 300 is abutted against the cover shell 100, comprising a plurality of axially extended mounting holes, for example, screw holes 303;304;305 disposed at the front side thereof and respectively fastened to the peripheral lugs 103;104;105 of the cover shell 100, a front opening 301, which receives the switch seat 101 and the switch 102 in the switch seat 101, a receiving hole 302 remote from the front opening 301, and a lamp unit 500 hinged to the peripheral wall of the receiving hole 302. The lamp unit 500 can be turned out of the receiving hole 302 and controlled to emit light when operating the power hand drill in the dark. When not in use, the lamp unit 500 can be turned inwards and received inside the receiving hole 302.

After disconnection of the respective electric connectors, the motor 600, the transmission gear box 200, the transmission gear box cover 201, the cover shell 100, and the torque adjusting ring 700 can be respectively detached from one another for the performance of an inspection or maintenance work. Because the switch seat 101 is formed integral with the cover shell 100, it does not fall from the cover shell 100 during the repair or maintenance work.

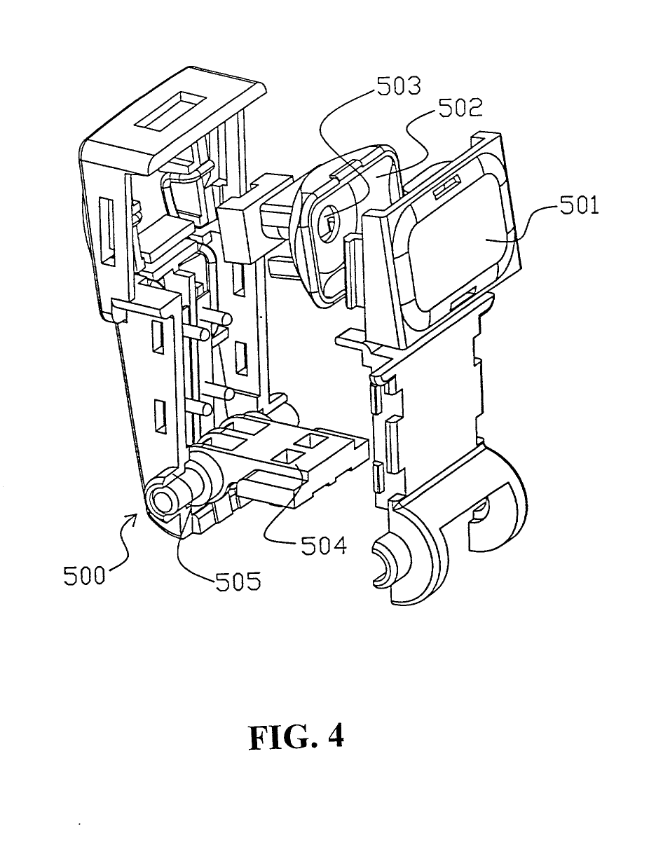

Referring to FIG. 4, the lamp unit 500 is shaped like a matchbox. When set in the operative position to illuminate the surroundings, the lamp unit 500 does not hinder the user's view. The lamp unit 500 comprises a pivot shaft 505 transversely disposed at the bottom side thereof and pivotally coupled to the pivot holes 302A at two sides of the receiving hole 302 of the housing 300, a lens 501 disposed near the top side thereof, lamp socket 503 aimed at the lens 501 and adapted to hold a lamp bulb, and a reflector 502 disposed behind the lens 501 and spaced around the lamp socket 503.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A power hand drill outer shell arrangement comprising a cover shell and a housing, wherein said cover shell comprises a plurality of equiangularly spaced peripheral lugs and a switch seat extended from one side thereof and holding a transmission gear box control switch; said housing is abutted against said cover shell, comprising a plurality of axially extended mounting holes disposed at a front side thereof and respectively fastened to the peripheral lugs of said cover shell, and a front opening, which receives said switch seat.

2. The power hand drill outer shell arrangement of claim 1 wherein said housing further comprises a receiving hole 302 remote from said front opening, and a lamp unit hinged to the peripheral wall of said receiving hole and turned between an operative position outside said receiving hole and a non-operative position inside said receiving hole.

3. The power hand drill outer shell arrangement of claim 1 wherein said axially extended mounting holes of said housing are screw holes.

4. The power hand drill outer shell arrangement of claim 1 wherein said is shaped like a matchbox, comprising a pivot shaft transversely disposed at a bottom side thereof and pivotally coupled to pivot holes at two sides of the receiving hole of said housing, a lens disposed near a top side thereof, lamp socket aimed at said lens and adapted to hold a lamp bulb, and a reflector disposed behind said lens and spaced around said lamp socket.
